(19) United States
(12) Patent Application Publication
(10) Pub. No.: US 2016/0329051 A1
(43) Pub. Date: Nov. 10, 2016

(54) MULTIPLE MICROPHONES FOR SYNCHRONIZED VOICE INTERACTION

(71) Applicant: Blackfire Research Corporation, San Francisco, CA (US)

(72) Inventor: Ravi U Rajapakse, San Francisco, CA (US)

(21) Appl. No.: 15/147,626

(22) Filed: May 5, 2016

Related U.S. Application Data
(60) Provisional application No. 62/157,474, filed on May 6, 2015.

(51) Int. Cl. G10L 15/22; G10L 15/28; H04R 3/00

(52) U.S. Cl. CPC G10L 15/22; H04R 3/005; G10L 15/28; G10L 2015/225

(57) ABSTRACT

A system for operating multiple microphones for synchronized voice interaction, comprising an interaction manager that receives speech-based interaction from a plurality of audio input devices and provides audio feedback to a plurality of audio output devices, a synchronization manager that receives a plurality of audio streams and synchronizes the streams for playback, a plurality of audio input devices each comprising at least a microphone, and a plurality of audio output devices each comprising at least a speaker, and a method for operating multiple microphones for synchronized voice interaction.

### CROSS-REFERENCE TO RELATED APPLICATIONS

The present claims the benefit of and priority to U.S. provisional application Ser. No. 62/157,474 titled “MULTIPLE MICROPHONES FOR SYNCHRONIZED VOICE INTERACTION” filed on May 6, 2015, the entire specification of which is incorporated herein by reference in its entirety.

### BACKGROUND OF THE INVENTION

1. Field of the Art

The disclosure relates to the field of audio input, and more particularly to the field of using multiple microphones for synchronized voice interaction with electronic devices.

2. Discussion of the State of the Art

In the field of audio input, it is a common practice to utilize multiple microphones for noise cancellation or echo reduction during audio recording. By positioning multiple microphones, audio may be “heard” from various positions and orientations to allow software or hardware processing to account for variations such as echoes, reverberation, or other acoustic anomalies, enhancing the quality of recorded audio data. As speech-capable technologies have developed such as virtual assistant software programs like Apple SIRI™, these noise cancellation functions have been important in improving the usefulness of such interaction technologies by improving the recognition of spoken audio and removing unwanted audio to reduce “false positives”.

No current technology exists to utilize multiple microphones for synchronized audio interaction with such technologies, however. Synchronized audio would enable the use of multiple microphones to allow a user to move about a space while interacting naturally with a virtual assistant, for example. Multiple microphones may also be used to enable multiple participants to interact with a single speech-interaction technology simultaneously, something that is not possible in current implementations. Additionally, the use of multiple microphones as well as multiple speakers or other output devices, may enhance an overall user experience during interaction by enabling a user to freely “talk to a whole room”, where they may speak naturally from any position or orientation, and hear responses and feedback regardless of their location within a space. Current implementations do not allow for such use, and generally require a user to speak toward a listening device such as a smartphone or a stationary speaker in order to ensure optimum performance, and this operation inhibits natural interaction by breaking the user out of their normal activity whenever they wish to speak to the device.

What is needed, is a mean to operate multiple microphones for synchronized audio interaction, and to utilize synchronized audio feedback for enhanced interaction with speech-interaction technologies.

### SUMMARY OF THE INVENTION

Accordingly, the inventor has conceived and reduced to practice, in a preferred embodiment of the invention, a system and method for multiple microphones for synchronized voice interaction.

According to a preferred embodiment of the invention, a system for operating multiple microphones for synchronized voice interaction, comprising an interaction manager comprising at least a plurality of programming instructions stored in a memory operating on a network-connected computing device and adapted to receive speech-based interaction from a plurality of audio input devices and to provide audio feedback to a plurality of audio output devices, and to make interactions and audio feedback to a synchronization manager; a synchronization manager comprising at least a plurality of programming instructions stored in a memory operating on a network-connected computing device and adapted to receive a plurality of audio streams and synchronize the streams for playback via a plurality of audio output devices, and to synchronize a plurality of interactions for further processing; a plurality of audio input devices each comprising at least a microphone; and a plurality of audio output devices each comprising at least a speaker, is disclosed.

According to another preferred embodiment of the invention, a method for operating multiple microphones for synchronized voice interaction, comprising the steps of receiving, at an audio input device, an audio interaction; providing the audio interaction to a synchronization manager; synchronizing, at a synchronization manager, the audio interaction with other audio interactions; providing the synchronized interactions to an interaction manager; processing, at an interaction manager, the synchronized interactions; generating an audio feedback; synchronizing the audio feedback; and playing the audio feedback through an audio output device, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram of an exemplary system for operating multiple microphones for synchronized voice interaction, according to a preferred embodiment of the invention.

FIG. 6 is a method flow diagram illustrating an exemplary method for operating multiple microphones for synchronized voice interaction, according to a preferred embodiment of the invention.

### DETAILED DESCRIPTION

The inventor has conceived, and reduced to practice, in a preferred embodiment of the invention, a system and method for multiple microphones for synchronized voice interaction with electronic devices.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

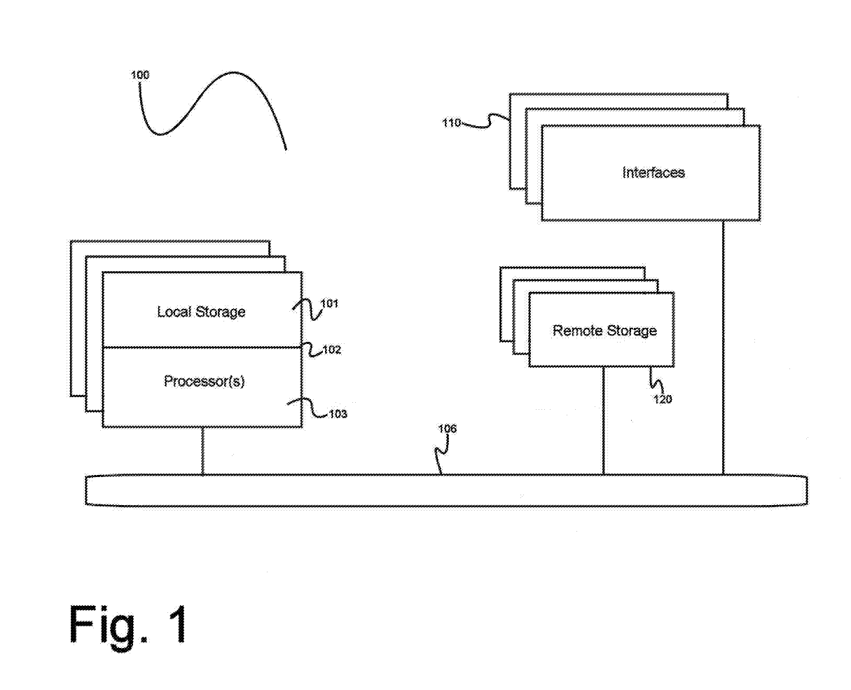

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

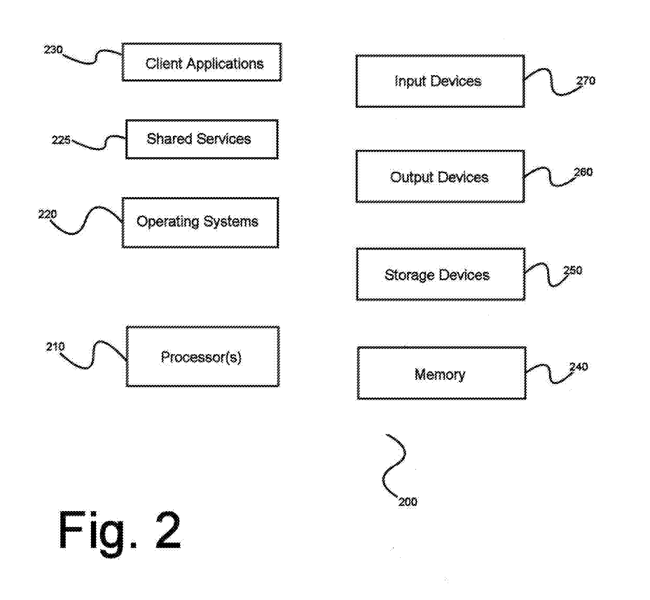

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

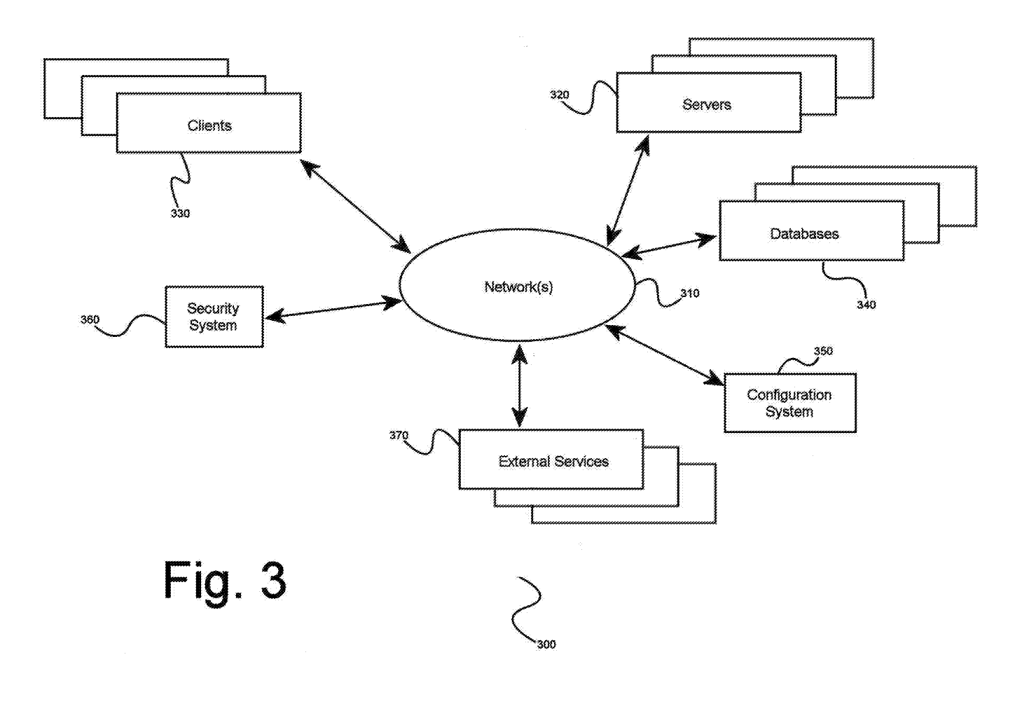

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

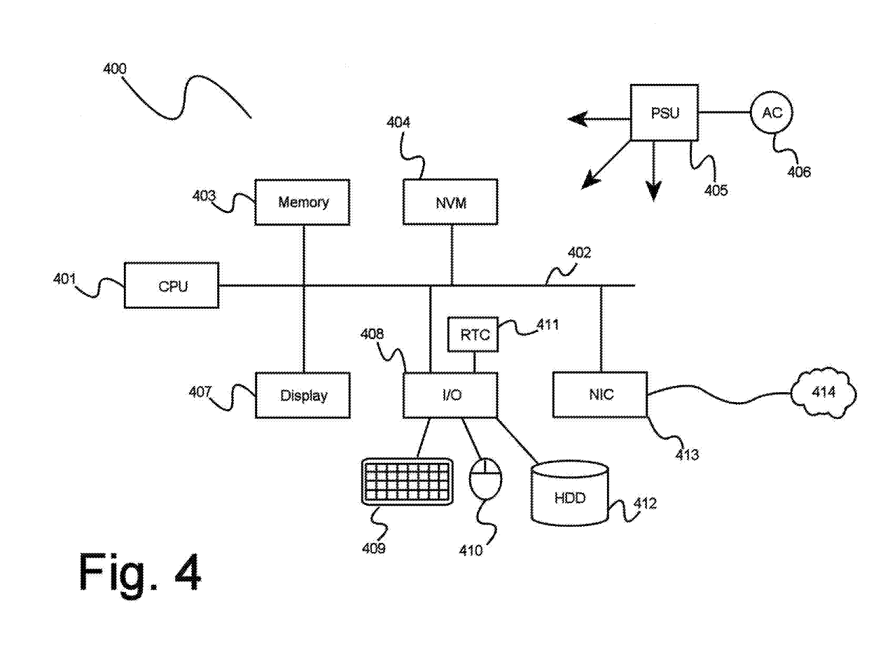

FIG. 4 shows an exemplary overview of a computer system 400 as may be used in any of the various locations throughout the system. It is exemplary of any computer that may execute code to process data. Various modifications and changes may be made to computer system 400 without departing from the broader scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

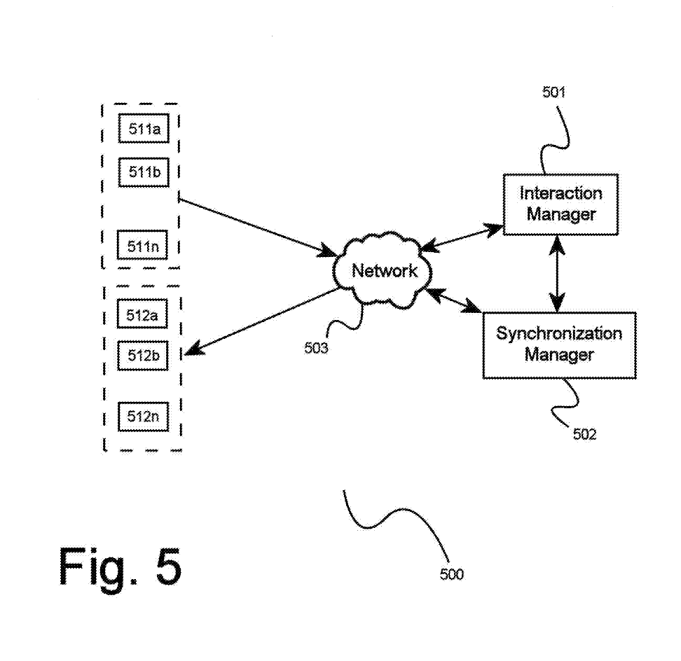

FIG. 5 is a block diagram of an exemplary system 500 for operating multiple microphones for synchronized voice interaction, according to a preferred embodiment of the invention. According to the embodiment, an interaction manager 501 may receive audio interactions from a plurality of audio input devices 511a-n such as microphones or audio input files (for example, to use computer shortcuts to voice commands by playing pre-recorded audio clips or generated audio such as from a text-to-speech software application). Interaction manager 501 may also provide audio-based feedback or responses for playback through a plurality of audio output devices 512a-n, such as to provide an audible confirmation of an interaction, play music, provide sound or speech information in response to an interaction request (as may be desired when interacting with a virtual assistant software application, for example), or any other such arrangement utilizing audio output. A synchronization manager 502 may receive multiple interactions or audio output from interaction manager 501 or from a plurality of audio input devices 511a-n, and may utilize various methods to enforce synchronization between multiple audio channels or streams. For example, using processor clock-based timing methods, audio channels may be blended into a single audio stream for use in monaural processing according to a particular use case, or a particular audio channel may be identified and processed individually while maintaining synchronicity with other audio channels. It should be appreciated that synchronicity may not necessarily be time-based and may utilize a variety of synchronization metrics such as network speeds or packet travel times, specific audio frequency or amplitude, physical location of an audio input device 511a-n or a calculated position of a speaker providing input through an audio input device 511a-n, or any other such means of grouping and synchronizing audio channels. According to a particular arrangement, audio channels or synchronized audio streams may be provided to external devices or services, such as third-party or cloud-based services communicating via a network 503, for example cloud-based automation services such as IFTTT™, HOOKS™, Amazon ECHO™, Google NOW™, Apple SIRI™, or other such products or services that may utilize audio or voice-based interaction or feedback.

It should be appreciated that audio input devices 511a-n and output devices 512a-n may be operating on a single hardware device or may be integrally or removably affixed together as a single unit, according to a particular arrangement or use case. For example, many hardware microphone and speaker devices common in the art utilize similar physical construction and signal processing, and may be used interchangeably as input or output devices as needed. In this manner, a single hardware device may serve as both an audio input and output, simplifying physical architecture and reducing cost while improving user experience by providing audio feedback from the exact location where audio input was received or “heard”. This may be utilized to give a user the impression of natural speech with another individual, by providing audio responses and hearing input from a “listener's point of view”.

Audio synchronization may be utilized according to a particular use case or arrangement for various purposes, such as to combine individual audio channels into a single audio stream for ease of processing, such as for use by virtual assistant software applications (such as Apple SIRI™, for example) that may be adapted to accommodate interaction with a single individual and may be confused or slowed by multiple input audio channels. Such an arrangement may be utilized to enhance single-user operation, by providing a user with the illusion of “speaking to the whole room” wherein they may speak naturally from any location and their interaction is processed and responded to similarly through the use of multiple synchronized audio devices, rather than “speaking toward a device”, such as when a user instinctively turns to speak in the general direction of a device they know is receiving their input. This may improve user interaction and adoption of speech-based interaction technologies, by encouraging natural interaction and removing a common source of inconvenience or “learning curve” generally associated with such forms of interaction.

In another synchronization example, multiple audio channels may be preserved while synchronization is enforced, such as to expand a virtual assistant to interact with multiple users in a confined space such as a room in a home or an office. For example, if two individuals wish to speak to a virtual assistant, their respective audio input may be preserved and associated with their individual locations (such as, “audio A came from microphone X”, for example), while being synchronized with one another so they may be processed in the order in which they were received. A virtual assistant may then provide audio responses to each speaker according to their individual interactions, by providing output through an output device nearest each individual (again, “audio A plays through speaker X”, for example), maintaining individual interactions for each user while operating a single virtual assistant. Such functionality may be further enhanced by allowing “shared interaction”, wherein an individual may participate in an interaction involving another individual, such as by asking a follow-up question after a first individual receives an audio response. This operation may greatly enhance the ease of interaction and overall user experience for virtual assistants and other voice-interactive technologies, and it should be appreciated that such functionality may be provided to a wide variety of third-party products or services according to various arrangements.

According to the embodiment, audio output devices 512a-n may be any form of software or hardware device adapted to receive and utilize audio signals, such as a hardware speaker or headphones. Output devices 512a-n may also comprise a variety of network-based output, such as for playing audio via a telephony communication network for use by an interactive voice response (IVR) system or recording by a voicemail service, or for interaction with users via a communication network. In this manner it can be appreciated that interaction with a system 500 according to the embodiment need not require all users (or, in fact, any users) to be physically located near any components of system 500, and all interaction may be possible via network communication according to a particular arrangement. For example, multiple users may be communicating in a group environment such as a conference call, and a “virtual participant” in the conference may be a plurality of audio input and output communication channels operating according to the system 500 of the embodiment. In such an arrangement, participants in the conference call may naturally interact with a virtual assistant, search engine, or deep-learning software such as WOLFRAM ALPHA™, by communicating naturally during the call while system 500 “listens” and responds to all participants. In this manner it can be appreciated that by utilizing the multiple microphone and audio synchronization capabilities of the invention, a variety of speech-interaction technologies may be enhanced with the capacity for more natural interaction as well as the option to be adapted for interaction with any arbitrary number of users simultaneously for natural group-based interaction.

### Detailed Description of Exemplary Embodiments

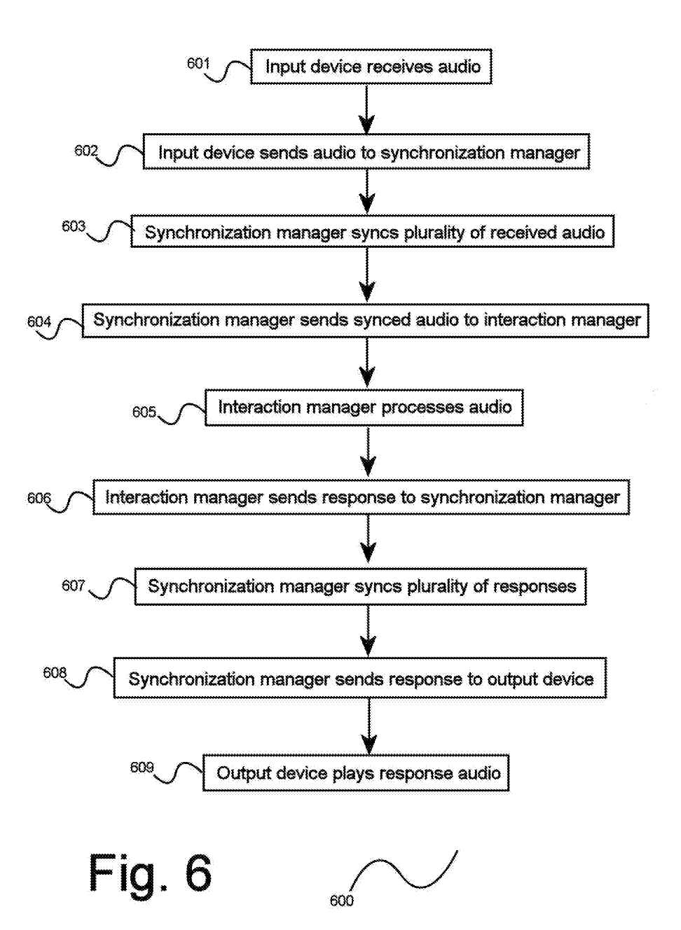

FIG. 6 is a method flow diagram illustrating an exemplary method 600 for operating multiple microphones for synchronized voice interaction, according to a preferred embodiment of the invention. In an initial step 601, audio may be received by an audio input device such as a microphone or a sound processor operated by an electronic device. In a next step 602, the audio input device may provide the audio as an “interaction” to a synchronization manager operated by a connected computing device. In a next step 603, the synchronization manager may synchronize the audio interaction with other received audio interactions, according to a particular use (such as for noise cancellation, echo reduction, combining multiple audio channels into a monaural audio stream, or operating separate audio interactions while maintaining their relative synchronicity, as described above with reference to FIG. 5). In a next step 604, the synchronization manager may provide synchronized interactions to an interaction manager, and in a next step 605 the interaction manager may process the synchronized interactions for use (such as for submission as search queries, dictation input, or providing to speech-enabled software applications such as virtual assistants). In a next step 606 the interaction manager may generate audio feedback, provide the feedback to a synchronization manager for synchronization (such as to play multiple audio responses simultaneously for a multi-user interaction use as described above, again with reference to FIG. 5) in a next step 607. The synchronization manager may then send an audio response to an output device in a next step 608, for example to play varied audio through multiple output devices for a “surround” audio effect, or to deliver a particular response to a specific user by sending it to a device located nearby, and in a final step 609 the audio feedback may be played through an audio output device such as a speaker, headphones, or communication network such as a telephone or voice over internet protocol (VoIP) connection.

The skilled person will be aware of a range of possible modifications of the various embodiments described above. Accordingly, the present invention is defined by the claims and their equivalents.

What is claimed is:

1. A system for operating multiple microphones for synchronized voice interaction, comprising:
an interaction manager comprising at least a plurality of programming instructions stored in a memory operating on a network-connected computing device and adapted to receive speech-based interaction from a plurality of audio input devices and to provide audio feedback to a plurality of audio output devices, and to make interactions and audio feedback to a synchronization manager;
a synchronization manager comprising at least a plurality of programming instructions stored in a memory operating on a network-connected computing device and adapted to receive a plurality of audio streams and synchronize the streams for playback via a plurality of audio output devices, and to synchronize a plurality of interactions for further processing;
a plurality of audio input devices each comprising at least a microphone; and
a plurality of audio output devices each comprising at least a speaker.

2. The system of claim 1, wherein at least a first audio input device is removably or permanently affixed to, or an integral component of, an audio output device.

3. The system of claim 1, wherein the synchronized interactions are provided to network-connected external devices for use.

4. The system of claim 3, wherein the external devices comprise at least a speech recognition software application.

5. The system of claim 3, wherein the external devices comprise at least a virtual personal assistant software application.

6. A method for operating multiple microphones for synchronized voice interaction, comprising the steps of:
receiving, at an audio input device, an audio interaction;
providing the audio interaction to a synchronization manager;
synchronizing, at a synchronization manager, the audio interaction with other audio interactions;
providing the synchronized interactions to an interaction manager;
processing, at an interaction manager, the synchronized interactions;
generating an audio feedback;
synchronizing the audio feedback; and
playing the audio feedback through an audio output device.
